(19) United States
(12) Patent Application Publication
(10) Pub. No.: US 2011/0136024 A1
(43) Pub. Date: Jun. 9, 2011

(54) Multifunctional material comprising a highly porous carbon structure with nanoscale mixed metal oxide deposits for catalysis

(76) Inventor: Fraser Wade Seymour, Middletown, MD (US)

(21) Appl. No.: 12/960,142

(22) Filed: Dec. 3, 2010

Related U.S. Application Data
(60) Provisional application No. 61/267,327, filed on Dec. 7, 2009.

(51) Int. Cl. H01M 12/06; B01J 21/18

(52) U.S. Cl. 429/405; 502/182; 502/184; 502/185; 502/101

(57) ABSTRACT

An oxygen electrode is created by forming a nanoscopic coating or nanoscopic deposits of mixed metal oxides as catalysts on a pre-formed, highly porous binder-free carbon structure. The highly porous carbon structure performs a role in the synthesis of the mixed oxide catalyst deposits as well as in providing a three-dimensional, electronically conductive support for the mixed metal oxide catalyst with a large surface area and desirable pore structure. The metal oxide mixture shall include two or more metal species. The multifunctional oxygen electrode materials, a process for producing the same and a metal oxygen battery using said oxygen electrode materials are disclosed.

This application claims the benefit of provisional application No. 61267327 filed on Dec. 7, 2009.

### Statement Regarding Federally Sponsored Research or Development

Not applicable

### BACKGROUND OF THE INVENTION

1. Field of the Invention

The present invention relates to engineered multifunctional materials for use as a catalysis electrode, and a method for producing the same. More specifically, this invention relates to a composite material consisting of a highly porous, pre-formed, binder-free carbon structure with nanoscopic deposits of a mixture of transition metal oxides. Uses for this invention include a gas diffusion electrode in a metal oxygen primary or in a metal oxygen secondary battery further comprising an anode, electrolyte, electrode separator, oxygen selective membrane and current collectors.

2. Brief Description of Related Art

Metal oxygen batteries in general and the lithium oxygen type in particular have large specific capacity. In the case of lithium, this high specific capacity is due to a high capacity anode material such as metallic lithium and a cathode reactant of oxygen supplied by the ambient environment such as air or water, or by an oxygen supply. The theoretical maximum capacity of lithium-oxygen batteries is determined by the complete electrochemical oxidation of metallic lithium anode. The theoretical specific capacity of lithium is 3862 mAh g.sup.-1, which is at least one order of magnitude higher than that of any types of electrode materials used in advanced lithium ion or lithium polymer batteries.

Lithium oxygen batteries using organic electrolyte or organic anolyte/basic aqueous catholyte are the focus of much interest because they allow the use of low cost non-noble metal catalysts and they are compatible with lithium. Considering the operational voltages 2.9-3.1 V for systems using non-aqueous electrolyte, the theoretical maximum energy densities of lithium oxygen batteries have been calculated based on charge balance and are 1300 Wh kg.sup.-1 and 1520 Wh L.sup.-1 in basic aqueous catholytes, and 2790 Wh kg.sup.-1 and 2800 Wh L.sup.-1 in organic electrolytes. This is not only much higher than that of any advanced batteries but also higher than that of fuel cells.

The nexus of electrochemical activity in oxygen batteries, oxygen electrodes simultaneously facilitate the diffusion of oxygen, electrolyte ions and solid-state electrons to reaction sites located on the oxygen electrode surface. They host oxygen reduction reaction (“ORR”) upon discharge and the breakdown of ORR products through oxygen evolution reaction (“OER”) during charge. The oxygen electrode is thus an essential factor in determining the performance on metal-oxygen batteries.

Below are example reactions for a lithium oxygen battery using an organic anolyte/alkaline aqueous catholyte system at 0.401V vs. NHE.

Cathode: O.sub.2+2H.sub.2O+4e sup.-→4OH.sup.-

Anode: Li→Li.sup.++ e.sup.-

Overall: 4Li+O.sub.2+2H.sub.2O→4Li.sup.++4OH.sup.-

The two discharge reactions for lithium oxygen battery using a single organic electrolyte are given below.

2Li+O.sub.2→2Li.sub.2O.sub.2 E.sup.0=3.10V

4Li+O.sub.2→2Li.sub.2O E.sup.0=2.91V

Although the theoretical energy density of lithium oxygen batteries is extremely large, the practical discharge capacity and energy density of lithium oxygen batteries are oxygen electrode-limited. Attempts at oxygen electrode construction comprise polymer-bound composites of powdered carbon with or without bulk catalyst as depicted in FIG. 1.

This approach relies on the porosity of the carbon powder granules to provide surface area to host reaction sites. Unfortunately, the pore structure of the powder is far from ideal for this oxygen electrode application in that a large amount of the reaction surface is provided by single-ended micropores (pore diameter <2 nm). These pores are readily and irreversibly filled and/or blocked by reaction products, limiting capacity, current density and life span. It is also suggested that as reaction product accumulates and agglomerate masses expand, pressure is exerted on the pore walls causing the electrode to break apart, resulting in electronic isolation and thereby creating areas of electrochemically inactive electrode materials.

The tortuosity of this pore structure also impedes oxygen diffusion causing oxygen starvation, thereby increasing capacity fade as a function of current density. It has been seen that at elevated discharge rates, reaction products comprising various lithium oxides accumulate near the oxygen interface, indicating the formation of an oxygen concentration gradient. This lack of oxygen diffusion into the electrode and low electrode utilization, combined with limited reaction rates serve to limit practical capacity and energy density of the battery.

A more suitable pore structure for such oxygen electrodes is believed to be an interconnected network of meso and small macropores (pore diameters between 2 nm and 200 nm) with reduced tortuosity that collectively promote gas diffusion and provide a large, accessible reaction surface that is less susceptible to pore blockage by reaction products.

Such an improved structure would also benefit from an interconnected framework capable of resisting pulverization and disintegration caused by ORR product formation and expansion.

One method of increasing capacity is to include a catalyst material within the oxygen electrode. Selection of catalyst material is an important determinant of catalytic efficacy. For example, manganese oxide is considered a highly effective catalyst for ORR in the lithium oxygen system.

Use of multiple catalyst materials can improve reaction rate and the stability of the catalyst itself. For example, the inclusion of additional materials such as oxides of nickel or magnesium with the manganese oxide may be beneficial by directing the ORR reaction to a single 4-electron pathway as opposed to a two-stage set of 2-electron pathway.

While the use of catalysts to promote ORR has a beneficial effect on discharge performance, the reduction of OER charge voltage potential to a level as close as possible to the discharge potential (i.e. reduction of charge/discharge voltage hysteresis) is important to improve storage round-trip efficiency. OER-promoting catalysts are useful to this end. Oxides of nickel, cobalt, magnesium and iron are examples of prospective OER-promoting catalysts in these systems.

The morphology of the catalyst materials is also an important determinant of the catalyst efficacy. Catalysis takes place at the surface of the materials. Bulk (i.e. micron scale) catalysts provide relatively low material utilization due to the limited surface/mass ratio (i.e. limited specific surface area) of the bulk materials. Bulk materials also do not tend to disburse evenly throughout the electrode, which causes non-uniform reactions and therefore areas of large reaction product accumulation.

There is a need in the art for performance improvements in metal-oxygen capacity, current density as well as reductions in charge/discharge voltage hysteresis and performance degradation from pore clogging/electrode disintegration. Such oxygen electrode improvements correlate to increased energy density, increased power density, increased storage efficiency and longer cycle life.

### SUMMARY OF THE INVENTION

The aforementioned need for improvements in electrode cycle life, current density, operating voltage range and storage capacity for a lithium oxygen battery are provided by the use of a multifunctional material consisting of a highly porous, pre-formed carbon structure, surface functionalized with a nanoscopic film or nanoparticle deposits comprising a mixture of transition metal oxides to promote ORR and OER. The mixed oxide is synthesized and simultaneously deposited, thereby forming a mixed oxide layer or deposits upon the surface throughout the pre-formed highly porous carbon structure. An example of such a material configured as a metal oxygen battery oxygen electrode is depicted in FIG. 2.

Use of a low density (i.e. ca. 15-25% solid/pore volume ratio) and through-connected carbon structure provides low tortuosity, interconnected pores of diameters generally from 5 to 100 nm. This pore structure promotes gas diffusion, electrolyte ion diffusion and provides a large, accessible reaction surface with low susceptibility to pore blockage from reaction products.

The pre-formed carbon structure further provides a through-connected electron transport network without the use of polymer binder. This carbon structure provides very high electronic conductivity of 20-50 Siemens cm.sup.-1 as well as improved cycle life as the carbon structure resists pulverization and disintegration caused by ORR product formation and expansion.

The binder-free, pre-formed highly porous carbon structure is surface-functionalized with nanoscale particles or a nanoscopic thin film of mixed metal oxides targeted to catalyze oxygen evolution in charge and reduction in discharge reactions. The nanoscale catalyst contains manganese oxide mixed with metals or metal oxides such as nickel and/or magnesium and/or cobalt and/or iron and/or tin and/or others such as aluminum, chromium, molybdenum, rhodium, iridium, lithium, osmium, rhenium, vanadium, tungsten, tantalum, palladium, lead and titanium. Manganese oxide may optimally be alpha, spinel or other phase.

Selection of catalyst materials, the phase of the materials, the overall loading of the materials, the relative loading of the materials, nanoscale morphology and distribution uniformity have an effect on catalyst efficacy. While optimal values for these parameters vary depending upon the electrolyte solvents and ions used, mixed oxide catalysts increase the discharge capacity, decrease the oxygen evolution voltage potential, improve catalyst stability and enhance reaction rates to increase current density.

A gas diffusion electrode such as a lithium oxygen electrode is fabricated as a single layer of multifunctional material described herein with a current collector or may be fabricated from multiple layers of multifunctional material described herein. If such an electrode is constructed from multiple layers, the outermost layer nearest the oxygen source will optimally comprise larger pore volume and larger average pore size than the innermost layer. The outermost layer may also possess reduced catalyst loading than the innermost. As well, the outermost layer may comprise a less wettable and/or less catalytic surface than the innermost layer. Such a graduated layered electrode facilitates gas diffusion into the electrode.

Collectively and individually, these characteristics increase metal oxygen battery energy density, power density, cycle efficiency and cycle life.

The multifunctional material not only is suitable as a material for metal oxygen battery use, but also may be used in an electrochemical capacitor or as fuel cell electrodes, for hydrogen absorption, for hydrogen production electrolysis or for capacitive de-ionization.

### DETAILED DESCRIPTION OF THE INVENTION

The present invention is directed particularly towards electrodes created by forming a multifunctional material; a pre-formed, highly porous carbon structure with nanoscopic deposits or a nanoscale layer of mixed metal oxides for use in electrochemical energy storage devices including primary and secondary metal oxygen batteries.

Hereinafter, various embodiments of the present invention will be explained in more detail with reference to the accompanying figures; however, it is understood that the present invention should not be limited to the following preferred embodiments and such present invention may be practiced in ways other than those specifically described herein.

Multifunctional materials comprise a pre-formed porous carbon structure with a nanoscopic surface coating less than 100 nm in thickness or surface deposits of mixed metal oxides produced by reduction/inclusion of precursor salts on the surface of a reductant pre-formed porous carbon structure when said pre-formed porous carbon structure is immersed in a precursor solution including a permanganate such as potassium permanganate, sodium permanganate or lithium permanganate and other metals or metal ions. Immersion is performed by chemical bath optionally stirred or sonicated during synthesis or immersion may be performed by pressure spray.

The synthesis/deposition process may be carried out at ambient room temperature and pressure or at elevated temperatures or pressures but in any event, below the boiling point and above the freezing of the precursor solution.

The precursor pH will be maintained at a generally neutral pH between 6 and 9 throughout the synthesis/deposition process.

The metal oxide mixture shall comprise structural water, ions and two or more metal oxides selected from a group consisting of oxides of manganese, nickel, cobalt, magnesium, iron, aluminum, chromium, molybdenum, rhodium, iridium, osmium, rhenium, vanadium, tungsten, tantalum, palladium, lead, tin and titanium. Lithium may be present with such a metal oxide deposit.

In one preferred embodiment, the pre-formed structure comprises a carbon fiber supported, hard templated carbon aerogel.

In one preferred embodiment, the mixed-oxide catalyst comprises a crystalline phase, a polycrystalline phase, an amorphous phase or any combination thereof.

In one preferred embodiment, the catalyst comprises alpha-phase or spinel phase manganese oxide and nickel oxide and/or cobalt oxide and/or iron oxide deposits on the pre-formed supported carbon structure.

The pre-formed porous carbon structure is selected from a group of three-dimensional structures consisting of supported carbon areogel, supported templated porous carbon wherein said support comprises carbonized electrospun polymer, carbon nanotubes or carbon nanofibres; carbonized electrospun polymer nanofiber structure; unaligned carbon nanofiber structure; unaligned carbon nanotube structure; or any combination thereof. Porous carbon structure may be amorphous, crystalline, polycrystalline or any combination of these.

In one preferred embodiment, a pre-formed porous carbon structure comprises a hard template-modified carbon aerogel supported by a carbon fiber or carbon nanotubes or carbon nanofiber or other structural support.

Prior to catalyst deposition, the pre-formed porous carbon structure has a pore volume between 75 to 90 percent and therefore carbon content between 10 and 25 percent. The pre-deposition carbon structure will possess a specific surface area greater than 400 m.sup.2 g.sup.-1, and an average pore diameter of approximately 20nm. The majority of the pore volume will have pore diameters ranging from 10 nm to 100nm.

Multifunctional materials may be used as-synthesized or may be annealed at temperatures above 100.degree.C and typically below 700.degree.C. Such annealing will convert a non-crystalline oxide to a crystalline phase and, when a lithium precursor is used, will enable solid-state electrode pre-lithiation and microstructure templating.

A gas diffusion electrode such as an oxygen electrode is fabricated as a single layer of multifunctional material described herein with or without a current collector (such as a metal mesh) or may be fabricated from multiple layers of multifunctional material described herein. If such an electrode is constructed from multiple layers, the outermost layer nearest to the oxygen source will optimally comprise larger pore volume and larger average pore size than the innermost layer. The outermost layer may also possess reduced catalyst loading than the innermost. As well, the outermost layer may comprise a less catalytic and/or less wettable surface than the innermost layer. Such a graduated layered electrode facilitates gas diffusion into the electrode.

A metal oxygen battery can be constructed using gas diffusion electrode comprising the multifunctional material described herein. Such a battery may further utilize organic-only electrolyte or organic anolyte/aqueous catholyte systems. In the case of lithium-oxygen battery, the organic electrolyte solvent/salt combination investigation may include lithium bis(trifluoromethanesulfonyl)imide in propylene carbonate/ethylene carbonate (LiTFSI in PC/EC) and/or ionic liquid 1-ethyl-3-methylimidazolium bis(trifluoromethanesulfonyl)imide (EMITFSI) and/or other formulations. These selections represent the need to facilitate oxygen diffusion not only by virtue of oxygen solubility in the electrolyte but also through management of electrolyte wetting on the electrode surface. Additional factors include solubility of reaction byproducts, ionic conductivity and specific capacity. Aqueous catholyte may include lithium hydroxide (LiOH) or other formulations. Porous Teflon sheet or other material may be used for oxygen selectivity at the oxygen interface. Anode materials such as sheet metal (such as lithium) or an intercalation or intermetallic material may be used in such a metal oxygen battery. For the mixed-electrolyte system, a LiSICON and/or NaSICON or other ion conducting solid electrolyte may be used as anolyte/catholyte barrier.

Active ion species and/or anode metal materials may include lithium, aluminum, magnesium, zinc, sodium, calcium, iron or any combination of these materials.

### BRIEF DESCRIPTION OF DRAWINGS

FIG. 1 shows a cross-sectional view of an electrochemical metal oxygen battery cell and the polymer-bound powder-based oxygen electrode. Shown are the anode, separator/electrolyte, current collectors and the oxygen electrode materials comprising microporous (pore diameter less than 2 nm) carbon powder, bulk single oxide catalyst and binder.

FIG. 2 shows a cross-sectional view of an electrochemical metal oxygen battery cell and the multifunctional oxygen electrode. Shown are the anode, separator/electrolyte, current collectors and the multifunctional oxygen electrode materials comprising mixed oxide deposits on preformed mesoporous carbon structure.

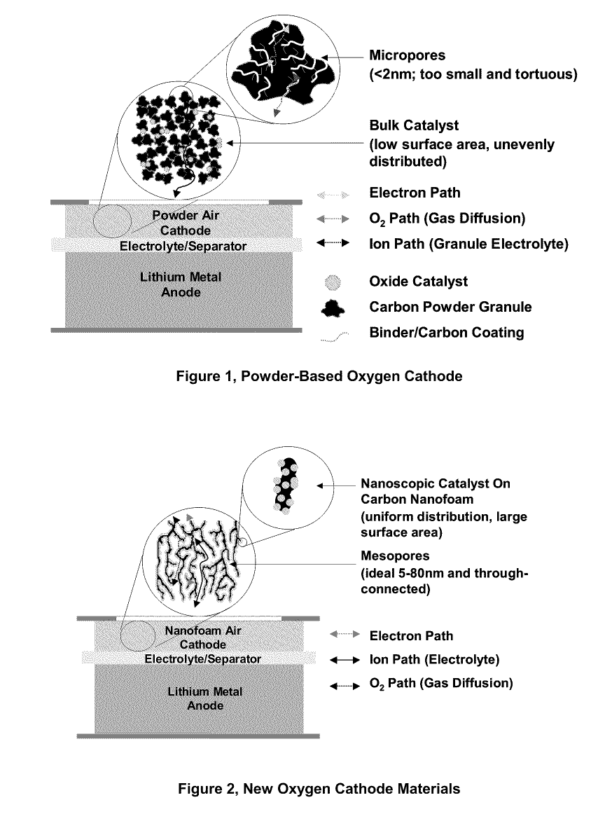

What is claimed is:

1. A multifunctional oxygen electrode material comprising a preformed binder-free porous carbon structure that is functionalized with surface deposits of mixed metal oxides as bifunctional catalysts, the electrode material wherein a majority of pore volume has a pore diameter larger than about 2 nanometers and smaller than about 100 nanometers.

2. The multifunctional oxygen electrode material of claim 1 wherein the surface deposits of mixed metal oxide catalysts are composed of a crystalline phase, a polycrystalline phase, an amorphous phase of two or more metals or metal oxides selected from manganese, nickel, cobalt, iron, aluminum, chromium, molybdenum, rhodium, iridium, lithium, osmium, rhenium, vanadium, tungsten, tantalum, palladium, lead, tin, titanium and magnesium; with an average metal oxide thickness greater than about 1 nanometer and less than about 30 nanometers.

3. The multifunctional oxygen electrode material of claim 1 wherein the preformed porous carbon structure has a pore volume in the range of about 75-90 percent versus the combined pore and solid material volume, a specific surface area greater than about 400 m.sup.2 g.sup.-1, and a majority of the pore volume having a pore diameter ranging from about 10 nanometers to about 100 nanometers.

4. The multifunctional oxygen electrode material of claim 1 wherein the preformed porous carbon structure is derived from the pyrolization of a resorcinol-formaldehyde polymer material with structural features formed by combined aerogel and silica templating processes, wherein the polymer is supported by electrospun polymer fiber, carbon nanotubes, carbon nanofibers or any combination thereof

5. A method for producing the multifunctional oxygen electrode material according to claim 1 wherein said catalyst mixed metal oxide deposits are produced by an oxidation/reduction reaction and inclusion of metal species occurring between the metal salt contained in an aqueous precursor solution and the surface of said porous carbon structure when said preformed porous carbon structure is infiltrated with said precursor solution comprising one of NaMnO.sub.4, KMnO.sub.4 or LiMnO.sub.4 in deionized water or a neutral pH buffer solution between pH 6 and 9, and one or more of Ni(NO.sub.3).sub.2 6H.sub.2O, Co(NO.sub.3).sub.2 6H.sub.2O, Fe(NO.sub.3).sub.3 9H.sub.2O, or other salts of metals selected from a group consisting of manganese, nickel, cobalt, iron, aluminum, chromium, molybdenum, rhodium, iridium, lithium, osmium, rhenium, vanadium, tungsten, tantalum, palladium, lead, tin, titanium and magnesium;
wherein infiltration is accomplished by immersion of said preformed carbon structure in or by pressure spray of a bath of said aqueous metal salt precursor; wherein said infiltration is performed with a precursor temperature of less than the boiling point of said precursor solution;
wherein said infiltration is followed by heat treatment of multifunctional material by microwave radiation or by convection at a temperature greater than about 100.degree.C and less than about 700.degree.C.

6. A metal oxygen battery comprising an oxygen selection membrane, an oxygen electrode, an ionically conductive and electronically isolating separator film comprising polymer or ceramic materials, an electrolyte or electrolytes and an anode separated by said separator and electrolyte or electrolytes, each electrode physically attached and electronically connected to a metal current collector; wherein the oxygen electrode comprises a single or a plurality of layers of multifunctional oxygen electrode material each according to any of claim 1; wherein if a plurality of layers, the layer or layers of multifunctional material nearest to the oxygen supply shall generally have a lower catalytic efficacy and a larger pore volume than the layer or layers of multifunctional material nearest to the anode; wherein active ion species and/or anode metal materials may include lithium, aluminum, magnesium, zinc, sodium, calcium, iron or any combination of these materials.

7. A metal oxygen battery comprising an oxygen selection membrane, an oxygen electrode, an ionically conductive and electronically isolating separator film comprising polymer or ceramic materials, an electrolyte or electrolytes and an anode separated by said separator and electrolyte or electrolytes, each electrode physically attached and electronically connected to a metal current collector; wherein the oxygen electrode comprises a single or a plurality of layers of multifunctional oxygen electrode material each according to any of claim 1; wherein if a plurality of layers, the layer or layers of multifunctional material nearest to the oxygen supply shall generally have a lower catalytic efficacy and a larger pore volume than the layer or layers of multifunctional material nearest to the anode; wherein active ion species and/or anode metal materials may include lithium, aluminum, magnesium, zinc, sodium, calcium, iron or any combination of these materials; wherein at least one electrolyte contains derivatives of alkali metals including but not limited to hydroxides, sulfates, nitrates and chlorides of said alkali metals or any combination thereof

8. A metal oxygen battery comprising an oxygen selection membrane, an oxygen electrode, an ionically conductive and electronically isolating separator film comprising polymer or ceramic materials, an electrolyte or electrolytes and an anode separated by said separator and electrolyte or electrolytes, each electrode physically attached and electronically connected to a metal current collector; wherein the oxygen electrode comprises a single or a plurality of layers of multifunctional oxygen electrode material each according to any of claim 1; wherein if a plurality of layers, the layer or layers of multifunctional material nearest to the oxygen supply shall generally have a lower catalytic efficacy and a larger pore volume than the layer or layers of multifunctional material nearest to the anode; wherein active ion species and/or anode metal materials may include lithium, aluminum, magnesium, zinc, sodium, calcium, iron or any combination of these materials; wherein the electrolyte is an ionic liquid such as 1-ethyl-3-methylimidazolium bis(trifluoromethanesulfonyl)imide or a solvent/salt combination wherein the solvent is selected from the group consisting of ethylene carbonate (EC), propylene carbonate (PC), diethyl carbonate (DEC), 1,2-dimethoxy ethane (DME), diethylene glycol dimethyl ether (i.e., diglyme DG), diethylene glycol diethyl ether (i.e., ethyl diglyme EDG), diethylene glycol dibutyl ether (i.e., butyl diglyme BDG), dipropylene glycol dimethyl ether (i.e., diproglyme DPG), 1,2-diethoxyethane (DEE) and 1-tert-butoxy-2-ethoxyethane (BEE) and the salt is selected from the group consisting of lithium bis(trifluorosulfonyl) imide, lithium hexafluorophosphate, lithium triflate, lithium bis(oxalato) borate, lithium tris(pentafluoroethyl) trifluorophosphate, lithium tetrafluoroborate, lithium perchlorate, lithium hexafluoroarsenate, lithium bromide, and lithium iodide or any combination of these materials.

9. A metal oxygen battery comprising an oxygen selection membrane, an oxygen electrode, an ionically conductive and electronically isolating separator film comprising polymer or ceramic materials, an electrolyte or electrolytes and an anode separated by said separator and electrolyte or electrolytes, each electrode physically attached and electronically connected to a metal current collector; wherein the oxygen electrode comprises a single or a plurality of layers of multifunctional oxygen electrode material each according to any of claim 1; wherein if a plurality of layers, the layer or layers of multifunctional material nearest to the oxygen supply shall generally have a lower catalytic efficacy and a larger pore volume than the layer or layers of multifunctional material nearest to the anode; wherein active ion species and/or anode metal materials may include lithium, aluminum, magnesium, zinc, sodium, calcium, iron or any combination of these materials; wherein the electrolyte is selected from one or more of i) a solvent/salt combination comprising an aluminum ion containing non-aqueous electrolyte in which aluminum ions are dissolved in an aqueous or organic solvent, such as formed by adding an aluminum halide and a quaternary ammonium salt to an organic etheric solvent; or ii) an ionic liquid such as those derived from imidazolium ion such as 1-allyl-3-methylimidazolium tetrachloroaluminate, pyridinium ion such as 1-(3-cyanopropyl) pyridinium tetrachloroaluminate, pyrrolidinium ion such as 1-Butyl-1-methylpyrrolidinium tetraaluminate, pyrazolium ion such as 1,2,4-trimethylpyrazolium tetraaluminate, or phosphonium ion such as triphenylmethylphosphonium tetraaluminate.

10. A metal oxygen battery comprising an oxygen selection membrane, an oxygen electrode, an ionically conductive and electronically isolating separator film comprising polymer or ceramic materials, an electrolyte or electrolytes and an anode separated by said separator and electrolyte or electrolytes, each electrode physically attached and electronically connected to a metal current collector; wherein the oxygen electrode comprises a single or a plurality of layers of multifunctional oxygen electrode material each according to any of claim 1; wherein if a plurality of layers, the layer or layers of multifunctional material nearest to the oxygen supply shall generally have a lower catalytic efficacy and a larger pore volume than the layer or layers of multifunctional material nearest to the anode; wherein active ion species and/or anode metal materials may include lithium, aluminum, magnesium, zinc, sodium, calcium, iron or any combination of these materials; wherein the electrolyte includes a magnesium ion containing non-aqueous electrolyte in which magnesium ions and aluminum ions are dissolved in an organic solvent, such as formed by adding metal magnesium, a halogenated hydrocarbon, an aluminum halide and a quaternary ammonium salt to an organic etheric solvent.

11. A metal oxygen battery comprising an oxygen selection membrane, an oxygen electrode, an ionically conductive and electronically isolating separator film comprising polymer or ceramic materials, an electrolyte or electrolytes and an anode separated by said separator and electrolyte or electrolytes, each electrode physically attached and electronically connected to a metal current collector; wherein the oxygen electrode comprises a single or a plurality of layers of multifunctional oxygen electrode material each according to claim 1; wherein if a plurality of layers, the layer or layers of multifunctional material nearest to the oxygen supply shall generally have a lower catalytic efficacy and a larger pore volume than the layer or layers of multifunctional material nearest to the anode; wherein active ion species and/or anode metal materials may include lithium, aluminum, magnesium, zinc, sodium, calcium, iron or any combination of these materials; wherein the second of two electrodes is selected from a group consisting of a metal, an inter-metallic compound; an alloy metal or metals, a metal carbide; a metal nitride; an intercalation compound composite carbonaceous paste comprising graphite powder, binder and conductivity enhancing carbon or a porous carbon structure or any combination of these materials.
